(19) United States
(12) Patent Application Publication
(10) Pub. No.: US 2005/0098374 A1
(43) Pub. Date: May 12, 2005

(54) Mount assembly for automotive power plant

(76) Inventor: Sung Je Moon, Gwangju (KR)

Correspondence Address: MORGAN, LEWIS & BOCKIUS LLP (SF), 2 PALO ALTO SQUARE, PALO ALTO, CA, 94306, US

(21) Appl. No.: 10/886,477

(22) Filed: Jul. 7, 2004

(30) Foreign Application Priority Data
Nov. 10, 2003 (KR) 10-2003-0079035

(51) Int. Cl. B62D 21/00

(52) U.S. Cl. 180/312

(57) ABSTRACT

A power plant mount assembly of a vehicle is interposed between a car body and a power plant to prevent vibration generated by a power plant from being transmitted to a car body. Such a mount includes an inner assembly that is integrated with an inner body member, a vibration-insulation member and an outer body. The inner body member is connected with the car body at a first side portion and has a recess formed inside to receive the inner assembly. The vibration-insulation member is formed with rubber material. The vibration-insulation member becomes one body with the inner body member, and is interposed between the inner body member and the outer body member so that vibration transmitted from a power plant to a car body may be effectively dampened and absorbed.

### CROSS-REFERENCE TO RELATED APPLICATIONS

This application claims priority of Korean Application No. 10-2003-0079035, filed Nov. 10, 2003, the disclosure of which is incorporated herein by reference.

### BACKGROUND OF THE INVENTION

(a) Field of the Invention

This invention relates to a mount assembly for an automotive power plant, and more specifically, to a multi-piece mount assembly that is easily adapted to different power plants and effectively prevents vibration and noise from being transmitted to a car body.

(b) Description of the Related Art

In a vehicle, a power plant generally refers to an engine, a clutch, and a transmission as comprising one assembly. When such a power plant is mounted in the engine room of a vehicle, vibration and noise that are inevitably generated are damped to allow minimum vibration and noise to be transmitted to a car body so that the comfort level of riding may be improved.

In mounting a power plant on a car body an above, a car body generally supports a power plant at 3 points to 6 points. For example, in a 4-point support it is feasible to interpose a pair of engine side mounts on both sides of the engine and a pair of transmission mounts on both sides of the transmission.

According to the prior art, such mounts must also be developed whenever new models of each car are developed, which increases design load and manufacturing cost of a car.

### SUMMARY OF THE INVENTION

Embodiments of the present invention provide a power plant mount assembly that not only support a power plant in a car body with stability but also effectively dampens and absorbs vibration transmitted from a power plant. The present invention also preferably provides a power plant mount assembly that may be easily assembled and applicable to a number of car models.

In a preferred embodiment of the invention, a power plant mount assembly of a car interposed between a car body and a power plant to prevent vibration generated from a power plant from being transmitted to a car body includes an inner assembly that is integrated with an inner body member and a vibration-insulation member and outer body member. The inner body member is connected with the power plant is preferably at its top portion. The outer body member is connected with the car body, preferably at a first side wall, with a recess for receiving the inner assembly being formed inside. The vibration-insulation member is formed with a resilient material, is integrally formed with the inner body member, and is interposed between the inner body member and the outer body member.

Preferably, at least one protruding portion is formed on the inner assembly inwardly facing the first side wall of the recess of the outer body member. At least one flange portion is formed on the first side wall of the outer body member and is disposed to support said protruding portion.

Preferably, a second side wall that faces the first side wall of the outer body member is formed so as to be open, and the inner assembly, that is integrated with the inner body member and the vibration-insulation member, is slidably inserted through the second side wall.

Preferably, third and fourth side walls that face the outer body member are formed in a V shape to support the inner assembly in a downward direction that is slidably inserted through the second side wall.

Preferably, each of the side vibration-insulation members facing the third and fourth side walls of the outer body member is a fixed plate, and each of the said third and fourth side walls is formed with at least one groove that guides the plate.

Preferably, a bottom portion of the said inner assembly and the recess bottom portion of the outer body member are spaced by an established interval.

### BRIEF DESCRIPTION OF THE DRAWINGS

FIG. 1 is an exploded assembly view of a power plant mount assembly of a vehicle according to one embodiment of the present invention.

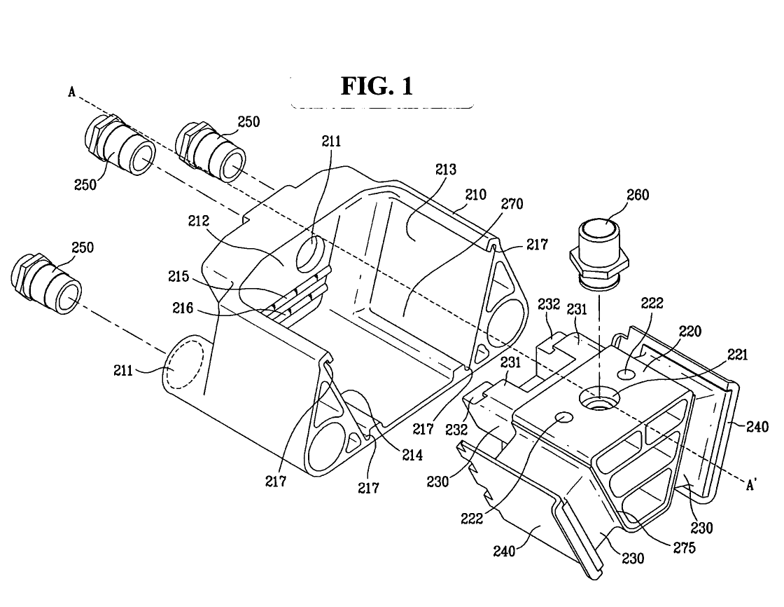

FIG. 2 is a cross-sectional view of the power plant mount assembly in FIG. 1.

FIG. 3 is a cross-sectional view of the power plant mount assembly in FIG. 2 when a load is applied.

### DETAILED DESCRIPTION OF THE PREFERRED EMBODIMENTS

The following describes the preferred embodiments of this invention in reference to the drawings attached.

In a preferred embodiment of the present invention, a power plant mount assembly of a vehicle comprises an outer body member 210, an inner assembly that is integrated with an inner body member 220 and a vibration-insulation member 230. The vibration insulation member 230 is interposed between the outer body member 210 and the inner body member 220. The outer body member 210 preferably may be made of aluminum as an example, and its top face and one side are open and have a recess 270 being formed inside.

In a first side wall 212 facing one open side is formed a plurality of holes 211 for fastening the outer body member 210 with a car body. A fastening member 250 is inserted into and fixed at the hole for fastening 211.

The inner body member 220 also preferably may be made of aluminum as an example, and a hole for fastening 221 is formed at its top portion. A fastening member 260 for connection with a power plant is inserted into and fixed at the hole for fastening 221. The fastening member 260 inside is formed to protrude toward the top portion of the inner body member 220 so that connection with a power plant may be easily made.

A plate 240 of the inner body member 220 is made of metallic material on which a vibration-insulation member 230 is integrally formed, preferably, for example, by injection molding. The vibration-insulation member 230 is preferably formed with rubber.

The end of the vibration-insulation member 230 toward the inner body member 220 is integrally formed with a metal plate 275, and this metal plate 275 is integrally formed with an inner body member 220, preferably by folding and other techniques.

The inner assembly that is integrally formed with the inner body member 220 and the vibration-insulation member 230 is received by the recess formed inside the outer body member, so a vibration-insulation member is interposed between an outer body member 210 and an inner body member 220 to insulate vibration of a power plant. Specifically, the inner assembly is slidably inserted toward a first side wall 212 of the outer body member 210 in a sliding fashion and received by the recess 270. At least one protruding portion 231, 232 is formed on the inner assembly inwardly facing the first side wall 212 of the outer body member 210. At least one flange portion 215, 216 is formed on the first side wall 212 of the outer body member 210 and is disposed to support the protruding portion 231, 232.

In addition, the third and fourth side walls 213, 214, facing the outer body member 210, are formed in a V-shape. The shape of the inner assembly that is integrally formed with the inner body member 220 and the vibration-insulation member 230 is formed corresponding to the slope of the V-form and supported. A pair of grooves 217 that is respectively parallel with the inserted direction of the inner assembly is formed at each side of third and fourth side walls 213, 214. A plate 240 faces the third and fourth side walls 213, 214 of the vibration-insulation member 230. Therefore, if the inner assembly is slidably inserted toward the outer body member 210, the groove 217 is combined with a corner of the plate 240 so as to guide the said inner assembly.

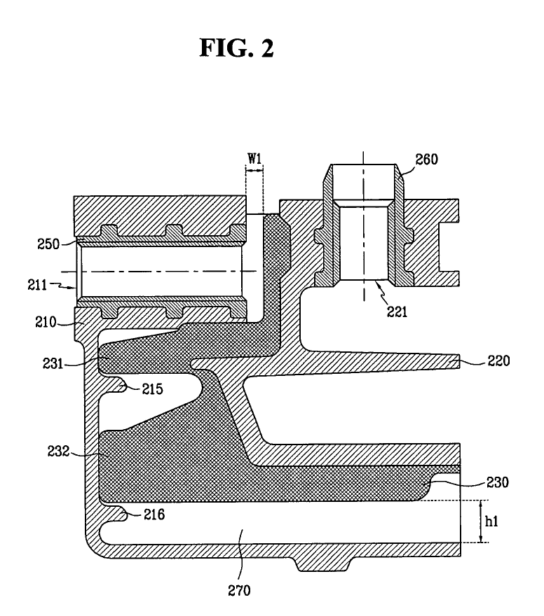

FIG. 2 illustrates a cross-sectional view in which an inner assembly and an outer body member 210 are integrally assembled. The bottom portion of the inner assembly and the recess 270 bottom portion of the outer body member 210 are separated by an established interval (h1), while a top side of the inner assembly and a top side of the outer body member 210 are spaced by an established interval (w1).

If the inner body member 220 vibrates in the recess of the outer body member 210 by vibration transmitted from a power plant, interference between the vibration-insulation member 230 and outer body member 210 is prevented, and vibration is reduced at the same time.

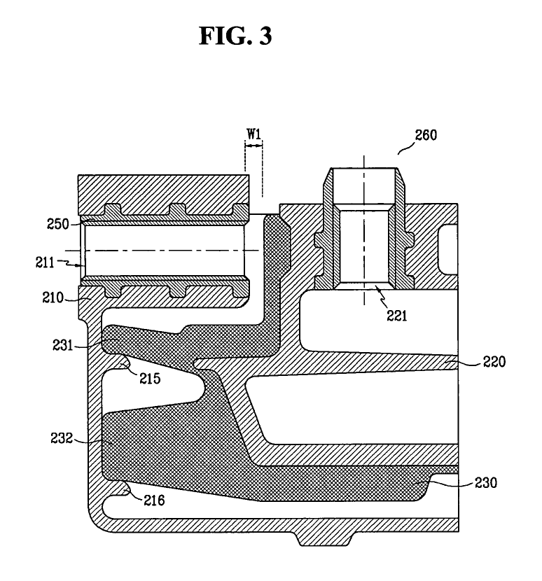

FIG. 3 illustrates a drawing of the condition under which the load of a power plant is applied with the inner body member 220 and outer body member 210. If a load is applied to an inner body member 220 from a power plant, the inner body member 220 moves slightly in the downward direction. As a result, the protruding portions 231, 232 of vibration-insulation member, which are integrally formed on the outer surface of the inner body member, move in a downward direction while being supported by flange portions 215, 216 of the outer body member 210. Protruding portions 231, 232 of the vibration insulation member 230 generate a certain elastic force that acts in an upward direction, while the protruding portions 231, 232 are elastically supported by the flange portions 215, 216 so as to attenuate vibration from a power plant.

According to the power plant mount assembly of a vehicle according to embodiments of the present invention, vibration transmitted from a power plant to a car body may be effectively dampened and absorbed. In addition, according to the power plant mount assembly of a car by this invention, its assembly is easy. Furthermore, since such a power plant mount assembly may be commonly applicable to a number of models with simple adjustment, design load and manufacturing cost may be reduced for development of new car models.

1. A power plant mount assembly configured to be interposed between a car body and a power plant to prevent vibration generated by the power plant from being transmitted to a car body, comprising:
an inner assembly connectable to the power plant including a metallic inner body member with a resilient member formed as one piece with the inner body member around at least a portion thereof; and
an outer body member connectable to the car body and defining a recess for receiving said inner assembly with the resilient member interposed between the outer body member and inner body member such that inner assemblies with different configurations may be selectively combined with the outer body member.

2. The power plant mount assembly according to claim 1, wherein:
at least one protruding portion is formed on the resilient member inwardly facing a first side wall within the recess of the outer body member; and
at least one flange portion is formed on the first side wall of the outer body member and is disposed inwardly in a position to support the protruding portion.

3. The power plant mount assembly according to claim 2, wherein a second side wall, opposite the first side wall is open, and the inner assembly is configured to be slidably inserted through the second wall.

4. The power plant mount assembly according to claim 3, wherein third and fourth side walls transverse to the first side wall are formed in a V shape to support the inner assembly in a downward direction.

5. The power plant mount assembly according to claim 4, wherein:
sides of the resilient members that face the third and fourth side walls of the outer body member include an outer fixed plate; and
at each said third and fourth side walls is formed at least one groove that guides said plates.

6. The power plant mount assembly according claim 5, wherein a bottom portion of the inner assembly and the recess bottom portion of the outer body member are spaced apart when assembled.
